(19) United States
(12) Patent Application Publication
(10) Pub. No.: US 2024/0005465 A1
(43) Pub. Date: Jan. 4, 2024

(54) ENHANCED VISION PROCESSING AND SENSOR SYSTEM FOR AUTONOMOUS VEHICLE

(71) Applicant: Tesla, Inc., Austin, TX (US)

(72) Inventors: Matthew Oswald, Austin, TX (US); Ron Rosenberg, San Francisco, CA (US)

(21) Appl. No.: 18/217,409

(22) Filed: Jun. 30, 2023

Related U.S. Application Data
(60) Provisional application No. 63/367,575, filed on Jul. 1, 2022.

(51) Int. Cl. G06T 5/50; G06V 20/56; G06T 3/40

(52) U.S. Cl. CPC G06T 5/50; G06V 20/56; G06T 3/4015; G06T 2207/20221; G06T 2207/30252

(57) ABSTRACT

Systems and methods for enhanced vision processing and sensor system for autonomous vehicle. An example method includes obtaining a plurality of raw images of a real-world scene associated with different integration times for individual pixels, determining a lux estimate for the real-world scene, selecting an analog gain to be applied to the plurality of raw images, applying the analog gain to the plurality of raw images, selecting an integration time for individual pixels of the plurality of raw images, selecting a digital gain to be applied to the plurality of raw images, applying the digital gain to the plurality of raw images, forming an output image based on a combination of the plurality of raw images, wherein each pixel of the output image is based on a corresponding pixel of an individual raw image.

### CROSS-REFERENCE TO RELATED APPLICATIONS

This application claims priority to U.S. Provisional Patent App. No. 63/367,575 titled “ENHANCED VISION PROCESSING AND SENSOR SYSTEM FOR AUTONOMOUS VEHICLE” and filed on Jul. 1, 2022, the disclosure of which is hereby incorporated by reference in its entirety for all purposes.

### TECHNICAL FIELD

The present disclosure relates to a sensor system for a vehicle. More particularly, the present disclosure relates to techniques for enhanced processing using a sensor system.

### BACKGROUND

Vehicles are increasingly using sensors for disparate purposes. For example, sensors may be used to detect a vehicle's proximity to an obstacle. In this example, the vehicle may provide alerts to the driver which are indicative of the vehicle's distance to the obstacle. As another example, sensors may be used to activate headlights during the evening, in tunnels, and so on.

Certain vehicles, such as autonomous vehicles, may use sensors to detect objects which are proximate to the vehicles. For example, an autonomous vehicle may use passive and/or active sensors to sense objects in a real-world environment and identify a path to a destination. However, accurately detecting objects can be complicated by environmental factors. As an example, poor lighting conditions can impact the reliable determination of nearby object. Thus, there remains a need for improved sensor systems which can operate in a variety of environments.

### BRIEF DESCRIPTION OF THE DRAWINGS

The disclosed technology is described with reference to the accompanying drawings, in which like reference characters reference like elements, and wherein:

FIG. 1 is a block diagram illustrating an example autonomous or semi-autonomous vehicle which includes a multitude of image sensors and an example processor system.

FIG. 2A is a block diagram of the example processor system generating an enhanced image according to the techniques described herein.

FIG. 2B is a block diagram illustrating detail of the example processor system generating the enhanced image.

FIG. 2C illustrates a comparison of a baseline image and an enhanced image generated according to the techniques described herein.

FIG. 3 is a flowchart of an example process for generating an enhanced image based on images associated with different integration times.

FIG. 4 illustrates an example camera hardware system including a camera enclosure included on a vehicle.

FIG. 5 illustrates an enhanced frit for the example camera hardware system.

FIG. 6 illustrates an example camera hardware system which includes use of a hood.

FIG. 7 is a block diagram illustrating an example vehicle which includes the vehicle processor system and camera hardware system.

### DETAILED DESCRIPTION

This disclosure describes enhanced processing of image information from image sensors (also referred to herein as cameras) positioned about a vehicle, for example to generate clearer (e.g., less noisy) images for use in autonomous or semi-autonomous driving. This disclosure additionally describes an enhanced camera hardware system which is usable to obtain images with less visual artifacts. For example, the enhanced camera hardware system may reduce the occurrence of unwanted light bouncing into the image sensors. As will be described, the images may be processed to reduce the inclusion of artifacts which may negatively impact the accurate detection of objects positioned about the vehicle. An example artifact may include color artifacts introduced, for example, due to flickering of streetlamps. Additional artifacts may include portions of an image which are over-exposed, under-exposed, noisy, and so on. In this way, the techniques described herein may provide clearer images and improve driving safety.

Under harsh or sub-optimal lighting conditions, cameras may produce images which are too dark such that dark colored objects are indiscernible. Under brighter lighting conditions, cameras may produce images which are too bright such that portions are overexposed or have color artifacts. With a standard vehicle camera that does not perform desirably under harsh lighting conditions, an autonomous or semi-autonomous vehicle might fail to detect objects and road conditions.

As will be described, a processor system may obtain, and process, images to reduce the existence of artifacts. The processor system described herein may obtain images from a multitude of image sensors positioned about a vehicle. For example, the processor system may obtain images at a particular frequency (e.g., 30 Hz, 36 Hz, 70 Hz, and so on). In this example, the image sensors may thus obtain images at times which are separated based on the particular frequency. As will be described, in some embodiments each image sensor may be a high dynamic range (HDR) image sensor which obtains sensor information for a particular time according to the particular frequency. The sensor information, which are referred to herein as raw images, may be produced using different exposures such as different integration times or shutter speeds. For example, a first raw image may be associated with a short integration time (e.g., 1/15 ms, 1/16 ms, 1/18 ms). As another example, a second raw image may be associated with a medium integration time (e.g., 0.9 ms, 1 ms, 1.1 ms). As another example, a third raw image may be associated with a long integration time (e.g., 15 ms, 16 ms, 17 ms).

The processor system may apply an autoexposure process to generate output images (also referred to herein as enhanced images) based on these raw images. As will be described, the autoexposure process may cause estimation of the brightness or illumination (e.g., the lux) for a real-world scene about the vehicle. In some embodiments, a lookup table or function may be used to determine exposure information for the estimated brightness or illumination. For example, a value of analog gain may be selected by the processor system (e.g., for use prior to an analog to digital converter). As another example, a value of digital gain may be selected by the processor system (e.g., for use subsequent to an analog to digital converter).

Subsequent to application of analog gain, and prior to application of digital gain, the processor system may form an output image from portions of the raw images obtained from an individual image sensor. For example, an HDR combination of the raw images may be effectuated. In some embodiments, the processor system may select a pixel included in each output image from corresponding pixels in the raw images. For example, a pixel at a first position (e.g., upper left) in the output image may be one of the pixels at the first position in the raw images which is not saturated. In this example, the raw image associated with a longest integration time may be preferred. Thus, the pixel at the first position may be from the raw image associated with the longest integration time in which the pixel is not saturated. Digital gain may then be applied to the HDR combination described above.

In some embodiments the image sensors may use a color filter (e.g., a Bayer filter). Each raw image may therefore include, for each pixel position, a value of an individual color (e.g., red, green, blue). Thus, in some embodiments the processor system may select, for a pixel at a first position in the output image, a value of an individual color for the first position based on the raw images. Once all pixels of the output image are selected, the processor system may interpolate the color information to generate an output image which includes color values for each pixel. For example, the processor system may apply a demosaic process.

As may be appreciated, artifacts may arise based on the exposure information determined by the processor system. For example, too high of a value of analog gain may cause portions of at least some of the raw images to be saturated. As an example, raw images of nighttime or evening may include bright portions (e.g., streetlamps, headlights, and so on) and darker portions. Since the overall brightness during nighttime or evening may be low, without the techniques described herein a high value of analog gain may be selected. This may cause the bright portions for, at least, the long integration time raw image to become saturated. The processor system may thus select pixels, or color values, from the short integration time raw image and/or medium integration time raw image for these bright portions. As described below, this selection of shorter integration time raw images may lead to artifacts.

For example, certain streetlamps may include light sources which rapidly turn on and off (e.g., light emitting diodes). Thus, if the processor system selects pixels, or color values, from the short integration time raw image there is a greater likelihood of the streetlamp appearing to flicker in successive images. For example, there is a greater likelihood of the output images depicting the streetlamp randomly alternating between being on and off. During the HDR combination, the flickering light may cause color artifacts to be introduced based on the color channels integrating at different times.

To address the above-described artifacts, the processor system may, instead, use digital gain to allow for a lesser value of analog gain to be selected. Since analog gain is applied prior to the HDR combination described above, the processor system may be more likely to select pixels or color values from longer integration time raw images. In this example, flicker may be avoided as the longer integration times may represent multiple cycles of a light turning on and off. Subsequent to the HDR combination, the digital gain may be applied to increase the exposure of the output image.

Block Diagram

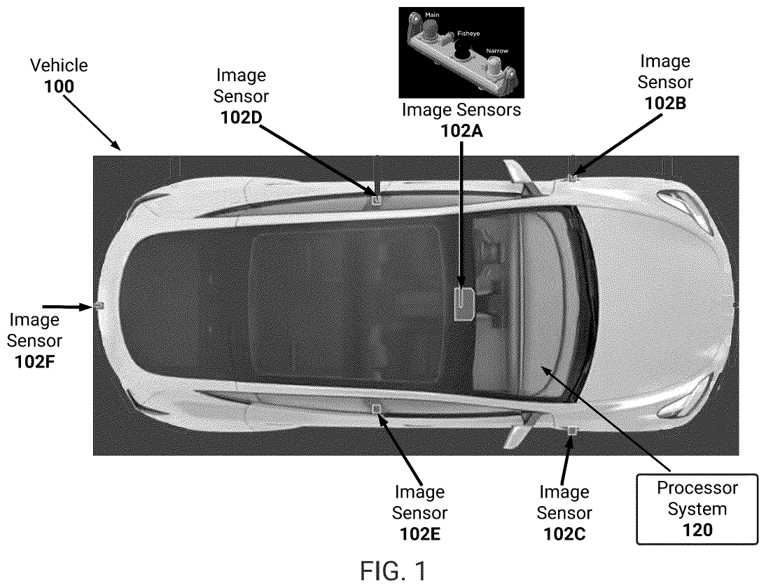

FIG. 1 is a block diagram illustrating an example autonomous or semi-autonomous vehicle 100 which includes a multitude of image sensors 102A-102F and an example processor system 120. For example, the image sensors 102A-102F may allow for a substantially 360-degree view around the vehicle 100. The image sensors 102A-102F may obtain images which are used by the processor system 120 to, at least, determine information associated with objects positioned proximate to the vehicle 100.

In certain embodiments, each of the image sensors 102A-102F can obtain sensor information that includes color values for certain colors (e.g., red, green and blue (RGB)). In some embodiments, image sensors 102A-102F can utilize Bayer filters which arranges RGB color filters on the image sensors 102A-102F. In other embodiments, the image sensors 102A-102F can sense full color information for individual pixels.

While the illustrated embodiments include image sensors 102A-102F, as may be appreciated additional, or fewer, image sensors may be used and fall within the techniques described herein.

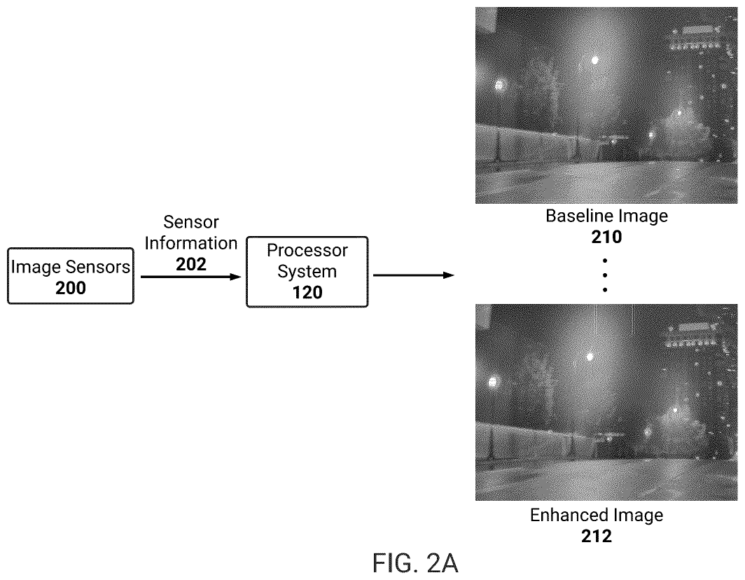

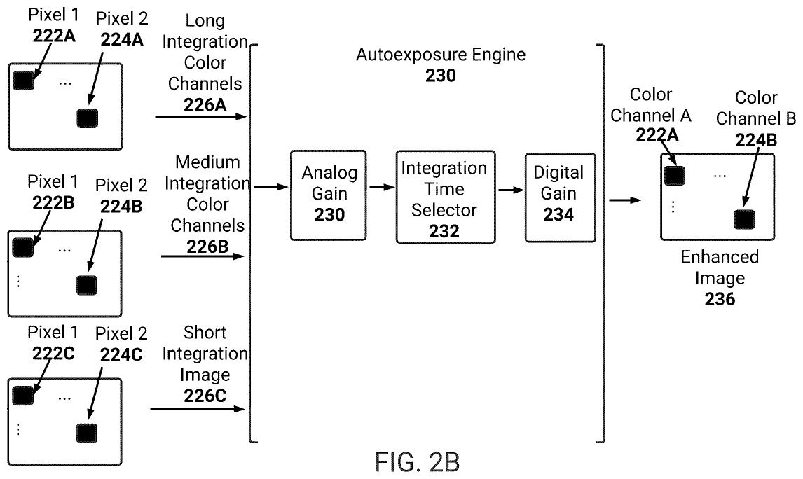

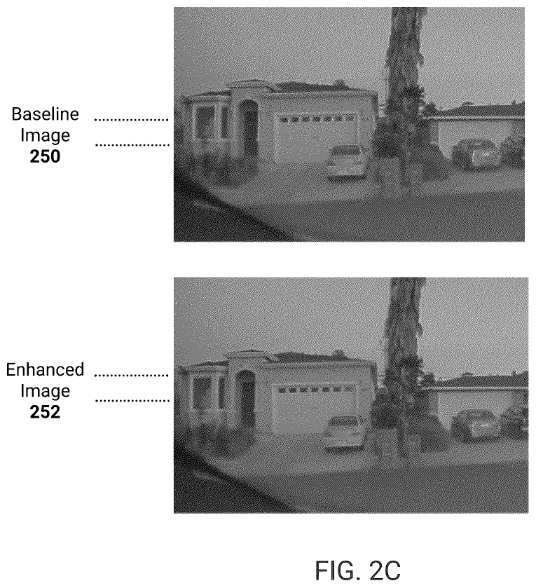

FIG. 2A is a block diagram of an example processor system 120 generating an enhanced image 212 according to the techniques described herein. As illustrated in FIG. 2A, an image sensor 200 may be used to output image information 202 for processing by the processor system 120. As will be described below, the image information 202 may be used to generate the enhanced image 212. In some embodiments, the enhanced image 212 may be used by a machine learning model for autonomous or semi-autonomous driving.

The sensor information 202 can include pixel by pixel color information. In some embodiments, the processor system 120 can receive images as raw Bayer-pattern data which includes only one of the RGB values for each pixel. The processor system 120 can also apply demosaic algorithms to process the raw sensor information 202 and produce full RGB values via interpolation. As illustrated in FIG. 2A, baseline image 210 depicts an example of color artifacts which can result from flickering light from streetlight.

When a high dynamic range (HDR) camera is used, such color artifacts shown in the baseline image 210 can happen when intense flickering light overexposes pixels. For example, overexposure may occur around the streetlight, on the ground where lightened, on fog or mist in the air, and so on.

An example HDR camera may obtain, as an example, three raw images consecutively for different integration times. These three images, as described above, may be used in an HDR combination to form an output image. For bright portions of a real-world scene, a shorter integration length raw image is more likely to be selected in the HDR combination to form the output image. However, a shorter integration time is more likely to be influenced by flickering light. For example, when sensing a dark environment with flickering streetlight, a longer integration time is more likely to be selected for the dark background while a shorter integration time is more likely to be selected for bright areas.

During the demosaic process, the processor system 120 may interpolate neighboring pixels which were integrated at slightly different time points and for different lengths of integration time. This may result in inaccurate full RGB values being interpolated for pixels around bright areas having inconsistent integration time points and lengths. Enhanced image 212 illustrates a reduction in the color artifacts included in baseline image 210.

FIG. 2B is a block diagram illustrating detail of the example processor system generating the enhanced image. As described, the image sensors described herein can be HDR sensors configured to consecutively obtain, as an example, three raw images. FIG. 2B therefore illustrates an example long integration image 226A, medium integration image 226B, and short integration image 226C. These raw images 226A-226C include pixels, with each pixel optionally being a color value of a particular color (e.g., a red color value, a green color value, or a blue color value). The images may be from a same imaging sensor or camera.

In some embodiments, the long integration image 226A can be sensed (e.g., exposed) for around 14 to 16 milliseconds (“ms”); the medium integration image 226B can be sensed (e.g., exposed) for around 0.5 to 1.5 ms; and the short integration image 226C can be sensed (e.g., exposed) for around 1/20 to 1/10 ms. In some embodiments, the long integration image 226A can be exposed for around 14.9 milliseconds (“ms”); the medium integration image 226B can be exposed for around 1 ms; and the short integration image 226C can be exposed for around 1/16 ms.

In some embodiments, the processor system 220 can implement an autoexposure engine 230 which determines lux estimation 231, applies analog gain 232, selects integration time 233, and applies digital gain 234. The autoexposure engine 230 first estimates the lux (e.g., illumination, brightness, and so on) of a real-world scene depicted in the raw images 226A-226C. In some embodiments, the lux estimate may be based on intensity statistics from the most sensitive color channel.

Based on the lux estimate, the autoexposure engine 230 can determine exposure information (e.g., analog gain, digital gain, and so on) to form an appropriate total exposure for the scene conditions. Analog gain may represent the amplification which is applied before sensed data is converted into digital information, while digital gain may be applied after sensed data is converted into digital information. In some embodiments, analog gain can be directly applied to image sensors to increase the sensors' sensitivity to obtain enhanced sensed information. In other embodiments, as shown in FIG. 2B, the analog gain 232 can be applied to the raw sensor information 202.

After the analog gain 232 is applied, the integration time selector 233 can perform an HDR combination by selecting among the raw images 226A-226C for individual pixels of an enhanced image 236. For an individual pixel of the enhanced image 236, the integration time selector 233 can select the longest integration time raw image which is not saturated (e.g., not over-exposed, such as not reaching a maximum color or pixel value). For example, as shown in FIG. 2B, the integration time selector 233 may select raw image 226A for pixel 1 222A of the enhanced image 236, raw image 226B for pixel 2 224B, and so on. After the integration time length is selected for each pixel, digital gain 234 is applied.

As described above, pixel 222A may represent a first value of a particular color (e.g., green). Thus, pixel 222B may represent a second value of the particular color and pixel 222C may represent a third value of the particular color. In this way, the enhanced image 236 may include the first value of the particular color for the pixel 222A. To provide remaining colors for the pixel 22A, a demosaicing technique may then be applied. In this way, RGB colors for each pixel of the enhanced image 236 may be determined.

In some embodiments, the color artifacts in the baseline image 210 can be reduced by increasing analog gain 230 while increasing the digital gain 212. The analog gain can be set at a high value such that a vehicle camera can be more sensitive to light and better sense dark scenes. For example, and with respect to FIG. 2A, the baseline image 210 can be taken with the analog gain 230 set to 22 times of its original sensitivity and the digital gain 234 set to 1 time the input image values. However, a high analog gain can cause color artifacts by increasing the likelihood of short integration shots being selected as explained above. Therefore, in some embodiments, the analog gain 230 is reduced to 11 times of its original sensitivity and the digital gain 234 set to 2 times the input image values to form the enhanced image 212.

In this way, the analog gain may optionally be capped to a particular threshold analog gain. For example, the exposure information may be determined, in some embodiments, via a lookup table. An example lookup table may indicate values of exposure information for a measure of illumination of brightness. This lookup table may thus include analog gain up to the particular threshold, and then increasing values of digital gain as the measure of illumination or brightness is reduced. The autoexposure engine 230 may therefore apply digital gain to increase exposure beyond that of the particular threshold analog gain. In this way, longer integration time raw images may be selected in the above-described HDR combination.

FIG. 2C illustrates a comparison of a baseline image and an enhanced image generated according to the techniques described herein. For example, FIG. 2C illustrates baseline image 250 as including noise (e.g., fuzziness) and enhanced image 252 with a reduction in noise.

As an example, noise in images may occur for similar reasons as described above when using HDR cameras. Image sensors (e.g., HDR cameras) for a vehicle can be tuned to be more sensitive to detect even dark-colored objects in reduced brightness. However, if the image sensors are configured to be very sensitive, even medium illumination or brightness can saturate long integration time raw images such that shorter integration time raw images are more likely to be chosen during an HDR combination. Thus, during the demosaic process, noise can be introduced due to the varying integration times of color channels. As described herein, the processor system may select reduced analog gain to ensure that longer integration time raw images are used during the HDR combination. Digital gain may then be applied to further boost the brightness (e.g., increase exposure).

Flowchart

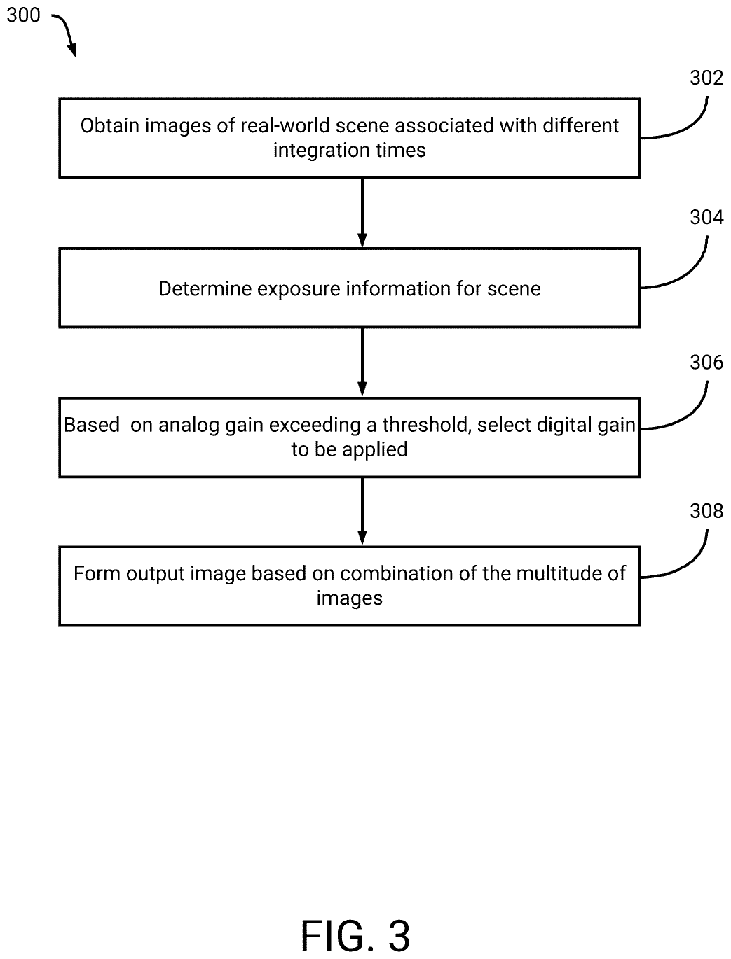

FIG. 3 is a flowchart of an example process 300 for generating an enhanced image based on images associated with different integration times. For convenience, the process 300 will be described as being performed by a system of one or more processors which may be included in a vehicle (e.g., the processor system 120).

At block 302, the system obtains images of a real-world scene about the vehicle. As described above, the images may represent raw images or sensor data associated with different integration times. The real-world scene may include, for example, a streetlamp which operates by adjusting its light source on and off according to a particular frequency. Thus, the light source may be visible and not visible for periods of time.

At block 304, the system determines a lux estimate for the real-world scene. The lux estimates may be based on intensity statistics from one or more color channels.

At block 306, the system selects an analog gain to be applied to the raw images or sensor data based on the lux estimate. The selection of the analog gain can be based on a lookup table. The lux estimate, as an example, may be below a threshold such that the scene is a night or evening time scene. As described above, a light source may be in the scene such that a portion of the images are brighter.

At block 308, the system selects integration time for individual pixels. The system can select the longest integration time raw image that is not saturated for each pixel. With respect to the light described above, as may be appreciated objects nearby the streetlamp may be brighter as they are lit up. Additionally, fog may be lit up by the streetlamp. The lookup table described above may limit an extent to which analog gain is applied to the images, allowing these objects, fog, and so on, to use pixels from the longer integration time raw images. In this way detail may be preserved for these portions, and indeed colors may correctly be identified.

At block 310, the system selects a digital gain to be applied. The selection of the digital gain can be based on the saturation level of one or more pixels. In some embodiments, the selection of the digital gain can be based on the lookup table. For example, a value of digital gain may be mapped to a value or analog gain. Optionally, digital gain may be selected based on the analog gain exceeding a threshold. For example, digital gain may be used in place of additional gain to ensure that longer integration time raw images are used.

At block 312, the system forms an output image based on the combination of the multitude images for individual pixels.

While the description herein describes use of a lookup table, as may be appreciated other techniques may be employed. For example, a machine learning model may be trained to output values of analog gain and digital gain based on input of the raw images. As another example, ranges may be defined within a continuum of total exposure, and for the ranges there may be an assignment of analog and digital gain values to be used.

The above-described technology may advantageously provide a benefit for night-time driving in which lights may be visible. For example, the signal to noise ratio (SNR) may be maximized using the techniques described herein while also minimizing flicker associated with those lights.

Example Hardware Improvements

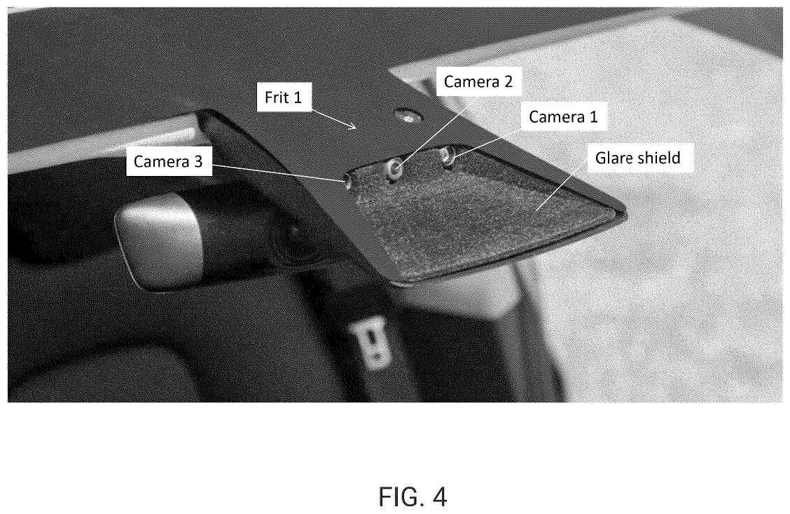

Mechanical improvements may be added to enable a vehicle camera system to better sense environments under direct sunlight. FIGS. 4-6 describe example improvements. The description below may be combined with the description above with respect to FIGS. 1-3. For example, the vehicle camera systems described below may be used to obtain sensor information (e.g., 202), images, as described above and may be the image sensors 102A, 200, and so on.

As shown in FIG. 4, a vehicle camera system 400 can include a frit 410 positioned at a top edge of a front windshield of a vehicle. The vehicle camera system 400 can have a camera 401, a camera 402, and a camera 403. The cameras 401, 402, and 403 can be a main camera, a fisheye camera, and a narrow camera respectively. When there is direct sunlight, for example, around noon, sunlight 405 can go right into camera 401 and overexpose an image. Even when sunlight is slightly lower, for example, in the afternoon, sunlight 405 can bounce off a surface (e.g., glareshield surface 420) into camera 402 and overexpose an image.

To further prevent sunlight (e.g., sunlight 406) bouncing into the cameras, anti-reflective paint (e.g., dark paint) can be used (e.g., instead of felt-like or fiber material currently shown in FIG. 4) on surfaces such as glareshield surface 420 (see FIG. 4). For example, the dark paint can absorb at least 98% of visible light to prevent light bouncing into the cameras. In some embodiments, a dark paint that can absorb at least 98%-99.9% of visible light can be used on the glareshield surface 420. In some embodiments, a dark paint that can absorb at least 99.99% of visible light can be used on the glareshield surface 420.

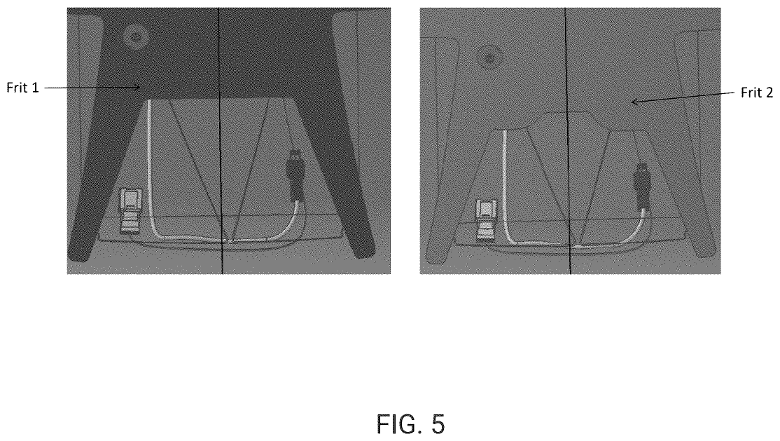

In some embodiments, an improved vehicle camera system 500, as shown in FIG. 5, can include a frit 510 which extends, as compared to the frit 410, along a front windshield and over the cameras. The frit 510 can be extend in a shape such that one or more of the cameras (e.g., a fisheye camera) are less covered and the rest of the cameras (e.g., a main camera and a narrow camera) are more covered as different cameras have different focal lengths. In some embodiment, a fisheye camera can be positioned between a main camera and a narrow camera and the frit 510 can be configured to extend along the front windshield less in the middle as shown in FIG. 5.

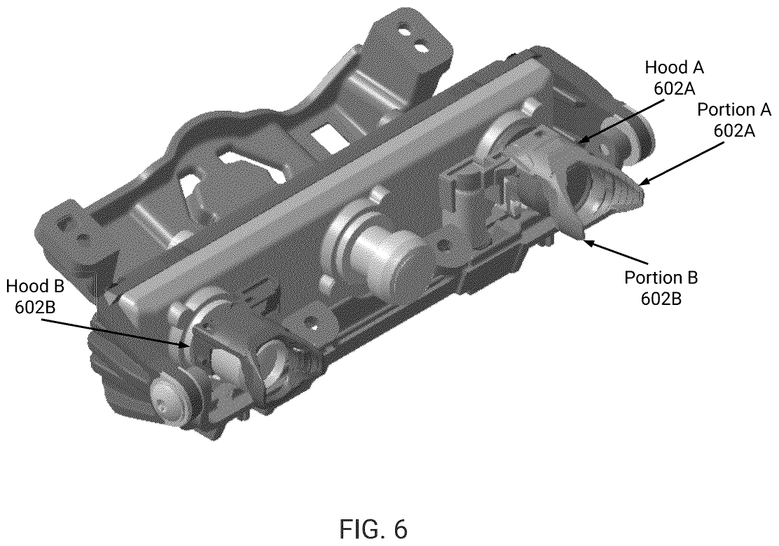

FIG. 6 illustrates an example camera hardware system which includes use of a hood. In some embodiments, the camera system described herein may include one or more camera hoods positioned on the cameras (e.g., positioned on the lens or lens housing). As illustrated in FIG. 6, at least a subset of cameras which are positioned on a vehicle to capture the forward direction may include hoods. As an example, hood A 602A is positioned about a left-most camera and hood B 602B is positioned about a right-most camera. These cameras may have different focal lengths and thus provide different views of the forward-direction.

The hoods 602A-602B may block light which comes from a side (e.g., horizontal) direction. For example, a left-most portion 604A is positioned such that it blocks light coming substantially horizontally in from the left-most direction. Similarly, a right-most portion 604B is positioned such that it blocks light coming substantially horizontally from the right-most direction. The hoods 604A-604B may therefore block light which is coming horizontally or within threshold angle of horizontal. The hoods 604A-604B may allow light from an upper direction. In this way, the cameras may avoid having light negatively affect imaging.

Vehicle Block Diagram

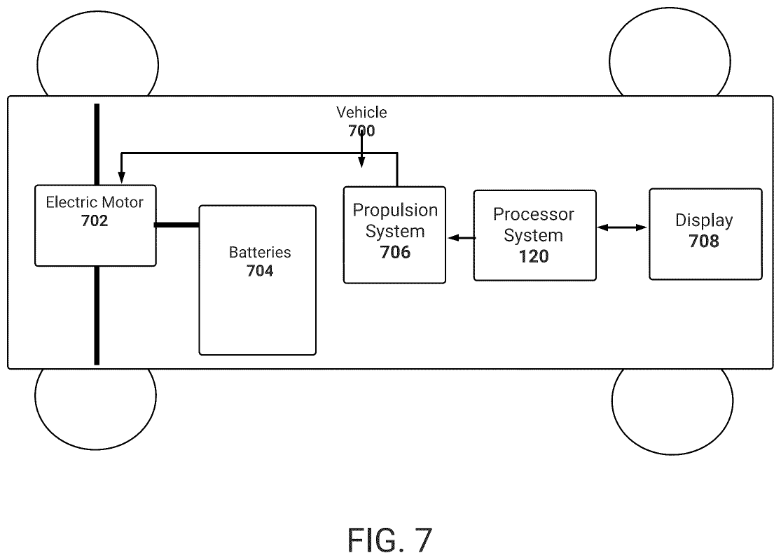

FIG. 7 is a block diagram illustrating an example vehicle which includes the vehicle processor system 120 and camera hardware system described above. The vehicle 700 may include one or more electric motors 702 which cause movement of the vehicle 700. The electric motors 702 may include, for example, induction motors, permanent magnet motors, and so on. Batteries 704 (e.g., one or more battery packs each comprising a multitude of batteries) may be used to power the electric motors 702 as is known by those skilled in the art.

The vehicle 700 further includes a propulsion system 706 usable to set a gear (e.g., a propulsion direction) for the vehicle. With respect to an electric vehicle, the propulsion system 706 may adjust operation of the electric motor 702 to change propulsion direction.

Additionally, the vehicle includes the processor system 120 which processes data, such as images received from image sensors 102A-102F positioned about the vehicle 700. The processor system 100 may additionally output information to, and receive information (e.g., user input) from, a display 708 included in the vehicle 700. For example, the display may present graphical depictions of objects positioned about the vehicle 700.

### Other Embodiments

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed vision processing and sensor system. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

What is claimed is:

1. A method implemented by one or more processors included in a vehicle, the method comprising:
obtaining a plurality of raw images of a real-world scene about the vehicle, the raw images being associated with different integration times for individual pixels which form the raw images;
applying an analog gain to the raw images, the analog gain being selected based on a lux estimate for the real-world scene; and
forming an output image based on a combination of the plurality of images, wherein each pixel of the output image is based on a corresponding pixel of an individual raw image selected based on its integration time.

2. The method of claim 1, wherein obtaining the plurality of raw images comprising using a high dynamic range (“HDR”) camera to obtain the plurality of raw images.

3. The method of claim 1, wherein obtaining the plurality of raw images comprising using a Bayer filter to obtain color information that includes a color value of an individual color channel for individual pixels of the plurality of raw images, and wherein a demosaic process is applied to interpolate the color information for individual pixels.

4. The method of claim 1, wherein selecting the analog gain to be applied to the plurality of raw images comprising selecting the analog gain according to a lookup table and the lux estimate for the real-world scene.

5. The method of claim 1, wherein applying the analog gain to the plurality of raw images comprising applying analog gain to raw sensor information of the plurality of raw images.

6. The method of claim 1, wherein individual pixels of the output image are selected from corresponding pixels of the raw images by identifying a corresponding pixel which is not saturated and which is associated with the longest integration time.

7. The method of claim 1, wherein obtaining the plurality of raw images comprises capturing a first raw image of the real-world scene for around 14 to 16 milliseconds, capturing a second raw image of the real-world scene for around 0.5 to 1.5 ms, and capturing a third raw image of the real-world scene for around 1/20 to 1/20 ms.

8. The method of claim 1, wherein determining a lux estimate for the real-world scene is based at least in part on intensity information from a most sensitive color channel of a plurality of color channels.

9. The method of claim 1, before applying the digital gain to the plurality of raw images, further comprising conducting a HDR combination by combining the individual pixels of the plurality of raw images associated with the selected integration time.

10. The method of claim 1, further comprising:
applying a digital gain to the output image.

11. The method of claim 10, wherein selecting the digital gain is based at least in part on a saturation level associated with the raw images.

12. A system configured for inclusion in a vehicle, the system comprising:
an image sensor configured to obtain a plurality of raw images of a real-world scene associated with different integration times for individual pixels,
a processor system configured to:
obtaining the plurality of raw images of a real-world scene about the vehicle, the raw images being associated with different integration times for individual pixels which form the raw images;
applying an analog gain to the raw images, the analog gain being selected based on a lux estimate for the real-world scene; and
forming an output image based on a combination of the plurality of images, wherein each pixel of the output image is based on a corresponding pixel of an individual raw image selected based on its integration time.

13. The system of claim 12, wherein the image sensor is a high dynamic range (“HDR”) sensor.

14. The system of claim 12, wherein the image sensor uses a Bayer filter to obtain color information containing a color value of an individual color channel for individual pixels of the plurality of raw images, and wherein the processor system is further configured to apply a demosaic process to interpolate the color information for individual pixels.

15. The system of claim 12, wherein individual pixels of the output image are selected from corresponding pixels of the raw images by identifying a corresponding pixel which is not saturated and which is associated with the longest integration time.

16. The system of claim 12, wherein the image sensor is configured to capture a first raw image of the real-world scene for around 14 to 16 milliseconds, capture a second raw image of the real-world scene for around 0.5 to 1.5 ms, and take a third raw image of the real-world scene for around 1/20 to 1/20 ms.

17. The system of claim 12, wherein the processor system is further configured to apply a digital gain to the output image, wherein selecting the digital gain is based at least in part on a saturation level associated with the raw images.

18. A camera system for a vehicle, the camera system comprising:
a camera housing positioned on a top edge of a windshield of a vehicle;
one or more cameras housed in the camera housing;
a surface on the camera housing proximate the one or more cameras is covered in a dark paint that absorb substantially all visible light reaching the surface; and
a frit disposed on the camera housing, wherein the frit extends along the windshield and at least partially over the one or more cameras, and wherein the frit hood at least partially blocks out sunlight without obstruct view of individual cameras.

19. The camera system of claim 18, wherein the frit is shaped to extend further over a first camera among the one or more cameras with a longer focal length, and extend less over a second camera among the one or more cameras with a shorter focal length.

20. The camera system of claim 18, further comprising a camera hood attached to the camera housing configured to at least partially block out sunlight coming from sides of the one or more cameras.
